(19) United States
(12) Patent Application Publication
(10) Pub. No.: US 2006/0093131 A1
(43) Pub. Date: May 4, 2006

(54) Adjustable wireless earpiece

(75) Inventor: Kerry John Cooper, Pleasantville, NY (US)

Correspondence Address: STEVEN A. GARNER;CONAIR CORPORATION, ONE CUMMINGS POINT ROAD, STAMFORD, CT, 06902, US

(73) Assignee: CONAIR CORPORATION

(21) Appl. No.: 10/980,371

(22) Filed: Nov. 3, 2004

(51) Int. Cl. H04M 1/00; H04M 9/00

(52) U.S. Cl. 379/431

(57) ABSTRACT

A wireless earpiece has a body with a speaker and various keys, and an adjustable ear support protruding from the upper body. The adjustable ear support is connected to the body by a first hinge and a rod. The first hinge allows a lower arm to rotate about a first axis with respect to the body. The rod allows the ear support to rotate about a longitudinal axis of the body. The lower arm is connected to a second arm through a second hinge. This allows the lower arm to rotate about a second axis. Such a configuration allows an operator to use and adjust a wireless earpiece with one hand.

### RELATED APPLICATIONS

None.

### TECHNICAL FIELD

The present invention relates to electronic equipment and, more particularly, to wireless earpieces, especially of the type that can be easily used and adjusted with one hand, and that can be configured in a wide variety of sizes for custom fitting.

### BACKGROUND OF THE INVENTION

The electronics industry has been in a period of large growth over the past decade. An example of this is the extreme proliferation of various devices, such as portable phones, radios or videogames. This equipment allows a user to take a phone, radio or other electronic device to different locations. This is accomplished in part by the use of an earpiece. The earpiece is secured by either being resting on the head or by being attached behind the ear.

While various known earpieces exist generally, the problem with such earpieces is that they can be cosmetically unattractive and uncomfortable to wear for long periods of time. Furthermore, they can be large, highly visible, cumbersome, and unsuitable for hands free operation while driving or walking. Many require more than one hand to adjust into a comfortable position and are not very secure once in position. These problems are especially true in environments such as driving or during athletic activities. Such shortcomings make it desirable to provide a lightweight, small and easily adjustable earpiece that can be used in different environments with minimal effort.

### OBJECTS OF THE INVENTION

It is an object of the invention to provide an electronic device that overcomes the above-mentioned shortcomings.

It is a further object of the present invention to provide electronic equipment to provide electronic equipment particularly well suited to allow a user to send and/or receive sounds via a wireless, small, lightweight and easily adjustable earpiece. These and other objects are described below or inherent with respect to the present invention.

### SUMMARY OF THE INVENTION

In the preferred embodiment of the invention, a wireless earpiece comprises a body with a speaker and various keys, and an adjustable ear support protruding from the upper body. The adjustable ear support is connected to the body by a first hinge and a rod. The first hinge allows a lower arm to rotate about a first axis with respect to the body. The rod allows the ear support to rotate about a longitudinal axis of the body. The lower arm is connected to a second arm through a second hinge. This allows the lower arm to rotate about a second axis. Such a configuration allows an operator to use and adjust a wireless earpiece with one hand. The lower arm and upper arm have a somewhat curved shape to conform to the general shape of an operator's ear.

### BRIEF DESCRIPTION OF THE DRAWINGS

FIG. 1A is a perspective view of a preferred embodiment of a device according to the present invention.

FIG. 1B is an exploded view of the embodiment shown in FIG. 1A.

FIG. 2 is a perspective view of a second embodiment of a device according to the present invention.

FIG. 3 is a side view of a preferred embodiment of a device according to the present invention.

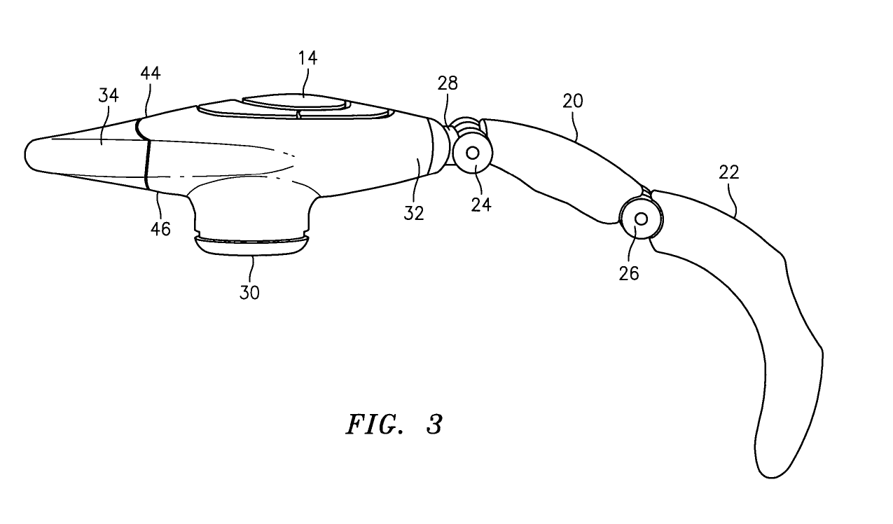

### DESCRIPTION OF THE PREFERRED EMBODIMENTS

The present invention is described in the preferred embodiments as directed to a wireless earpiece that can be used with electronic devices, such as telephones, radios and portable videogames. It is understood, however, that the present invention is not limited to such applications and, as understood by one skilled in the art, may be adapted for application to other similar uses.

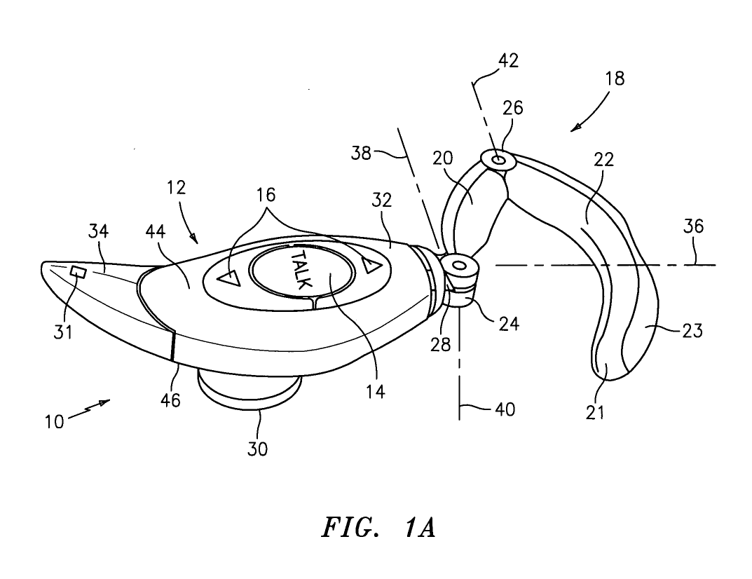

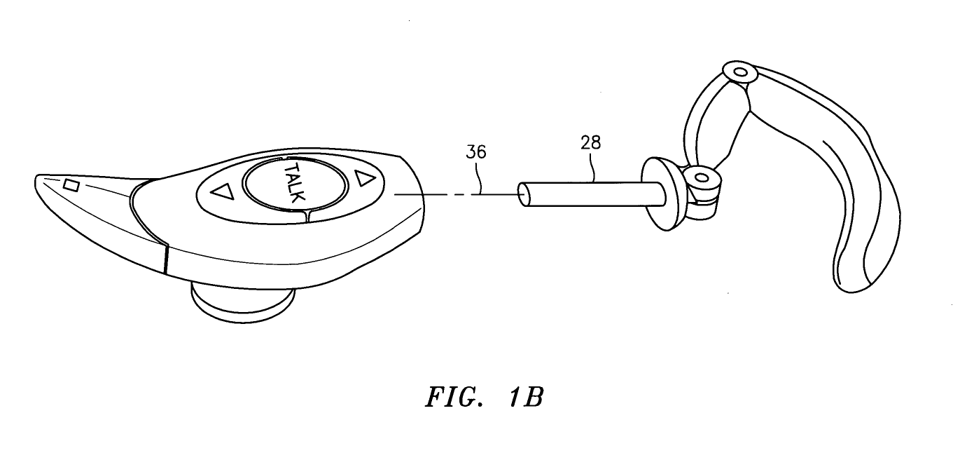

Referring to FIGS. 1A-B, wireless earpiece 10 can be used with phones, radios and other electronic devices. Earpiece 10 can be battery operated, or powered by a rechargable battery or cell. Earpiece 10 includes a body 12 having various function keys 14, 16 and a speaker 30. In a preferred embodiment, such function keys can control on/off and volume. It is contemplated that these keys or additional keys may be adapted to control other functions. Protruding from the upper body 32 is an ear support 18. The ear support 18 hooks securely over the top of an operator's ear to allow the operator to listen and/or talk without manually holding the earpiece 10.

The ear support 18 includes a lower arm 20 and upper arm 22. The ear support 18 is connected to the body via rod 28 received in an opening (not shown) in the body 12. This allows the ear support 18 to rotate about a longitudinal axis 36. The rod 28 may translate linearly along the axis 36 to adjust the position of the arms 20, 22 relative to the body 12. Ear support 18 is connected to the rod 28 via a first hinge 24. Rotation of the earpiece 18 about the axis 36 provides for a more comfortable and stable fit. Pivoting of the earpiece 18 about the hinge 24 provides another degree of custom fit. Lower arm 20 is connected to upper arm 22 via a second hinge 26. This second hinge 26 enables upper arm 22 to be rotated about second axis to allow for further adjustment of the earpiece 10. Upper arm 22 can be rotated about lower arm 20 up to the point where the arms 20, 22 come into contact with one another. Preferably, friction in hinges 24, 26 and rod 28 holds the arms 20, 22 in place until sufficient force overcomes the friction. In an alternate embodiment, hinges 24, 26 and rod 28 can be positionally indexed by conventional means (not shown). Arms 20, 22 have a somewhat curved shape to conform to the general shape of an operator's ear. The lower arm 20 and upper arm 22 can be constructed with two separate materials whereby the inner portion 21 can be made of a softer material for added comfort on the ear and the outer portion 23 can be made of a firmer material for added support.

The body 12 can have a generally oval shape and has a front surface 44 and a rear surface 46. On the front surface is a set of keys 14, 16 to allow for various functions such as turning the earpiece on/off or adjusting the volume. Attached to the rear surface 46 is a circular speaker 30 that is placed on an operator's ear to hear any incoming voices or sounds.

During use, the earpiece 10 is grasped by an operator's hand and the speaker 30 is placed on the operator's ear. The ear support 18 is then adjusted with a squeezing-like motion that causes rotation of the hinges 24, 26 and rod 28 to conform the ear support 18 to the operator's ear. This allows for using and adjusting the earpiece 10 with one hand rather than needing two hands.

Located on the front surface 44 of the lower body 34 is a hole 31 for an interior microphone (not shown). The interior microphone is located within the lower body 34 to allow an operator to transmit voice signals to others.

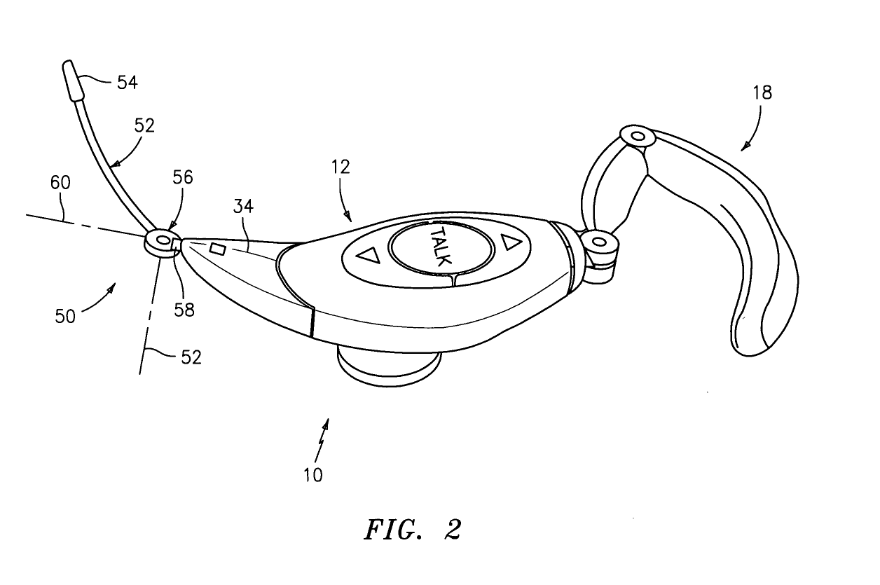

An alternative embodiment of the present invention is shown in FIG. 2. to include an exterior boom 50, in which a microphone 54 could be placed closer to an operator's mouth than an interior microphone through the use of a boom extension 52 that protrudes from lower body 34. The boom 50 can include a boom hinge 56 that allows the microphone 54 to be rotated about boom axis 52. It also can include a boom rod 58 to allow for rotation of the microphone 54 about second longitudinal axis 60. This allows for further adjustment of the microphone's location.

While the preferred embodiments of the present invention have been described herein, various modifications can be made without departing from the scope of the invention.

1. An electronic earpiece comprising:
a body;
a speaker on said body for emitting sounds;
a rod connected to said body;
a lower arm pivotally connected to said rod; and
an upper arm pivotally connected to said lower arm.

2. An electronic earpiece according to claim 1, wherein
said rod is slideably adjustable relative to said body.

3. An electronic earpiece according to claim 1, wherein
said rod is rotatably mounted to said body to rotate about a first axis.

4. An electronic earpiece according to claim 1, wherein
said rod is slideably adjustable and rotatably mounted relative to said body.

5. An electronic earpiece according to claim 1, further comprising
a first hinge for enabling said lower arm to rotate about an axis of rotation with respect to said rod.

6. An electronic earpiece according to claim 5, further comprising
a second hinge for enabling said upper arm to rotate about an axis of rotation with respect to said lower arm.

7. An electronic earpiece according to claim 6, wherein
said first hinge and said second hinge are generally parallel.

8. An electronic earpiece according to claim 3, wherein
said upper arm and said lower arm rotate about said first axis at the same rate.

9. An electronic earpiece according to claim 1, wherein
the position of said upper arm and said lower arm relative to said body is adjustable.

10. An electronic earpiece according to claim 6, wherein
said upper arm and said lower arm are held in place by friction in said first hinge and said second hinge, respectively.

11. An electronic earpiece according to claim 1, further comprising
a microphone.

12. An electronic earpiece according to claim 11, wherein
said microphone is located within said body.

13. An electronic earpiece according to claim 11, wherein
said microphone is located exterior to said body.

14. An electronic earpiece according to claim 1, further comprising
a set of function keys for controlling said earpiece.
